(19) United States
(12) Patent Application Publication
(10) Pub. No.: US 2025/0096477 A1
(43) Pub. Date: Mar. 20, 2025

(54) FLANGE CLAMPING DEVICE FOR SMALL ANTENNA PEDESTALS

(71) Applicant: Raytheon Company, Waltham, MA (US)

(72) Inventors: Paul J. Marchetti, Dracut, MA (US); Craig Richardson, Watertown, MA (US); Michael A. Toomey, Marlborough, MA (US)

(21) Appl. No.: 18/370,102

(22) Filed: Sep. 19, 2023

(51) Int. Cl. H01Q 15/14; H01Q 1/12

(52) U.S. Cl. CPC H01Q 15/14; H01Q 1/1207

(57) ABSTRACT

A clamping device for securing a first component to a second component is disclosed. The clamping device includes a mounting flange coupled to the first component, a mounting seat coupled to the second component, and a clamping ring configured to be rotatably seated on the mounting flange such that the mounting flange is disposed axially between a first end of the clamping ring and the mounting seat upon assembly. The mounting seat includes a plurality of first locking ramps disposed about a circumference of the mounting seat and extending radially outward from the mounting seat. The clamping ring includes a plurality of second locking ramps disposed about an inner circumference and extending radially inward from a second end of the clamping ring. The plurality of second locking ramps is configured to engage the plurality of first locking ramps upon securing the first component to the second component.

### STATEMENT OF GOVERNMENT INTEREST

This invention was made with U.S. Government support. The government has certain rights in the invention.

### BACKGROUND

The present disclosure is directed generally to component assembly and more particularly to a device for “in-the-field” mounting of equipment to a base structure.

Prior solutions for in-the-field mounting of man-transportable equipment, including but not limited to antenna pedestals, weapon systems, telescopes, cameras, sensors, and similar equipment, to a base structure, such as a tripod, generally require tools and assembly of multiple loose components and/or are susceptible to issues when exposed to a tactical operational environment. Fully threaded clamping rings are more susceptible to dirt and debris contamination, require finesse to start threading in a field environment, and often bind up when dirty or damaged. V-section band clamps require tools and are a separate part, which is more easily lost or damaged. Threaded fasteners and captive screw assemblies require tools, create localized high stress, and are susceptible to galling with repeated use in the field environment. Moreover, assemblies with threaded fasteners or captive screws are time consuming to fasten.

A need exists for a clamping device that does not require use of loose hardware or tools for assembly, which can allow for rapid setup, and which provides the requisite stiffness and security required for accurate assembly and use of equipment in harsh environments (e.g., high winds).

### SUMMARY

A clamping device for securing a first component to a second component is disclosed. The clamping device includes a mounting flange coupled to the first component, a mounting seat coupled to the second component, and a clamping ring configured to be rotatably seated on the mounting flange such that the mounting flange is disposed axially between a first end of the clamping ring and the mounting seat upon assembly. The mounting seat includes a plurality of first locking ramps disposed about a circumference of the mounting seat and extending radially outward from the mounting seat. The clamping ring includes a plurality of second locking ramps disposed about an inner circumference and extending radially inward from a second end of the clamping ring. The plurality of second locking ramps is configured to engage the plurality of first locking ramps upon securing the first component to the second component.

A method of securing a first component to a second component includes aligning a plurality of first locking ramps disposed about an inner circumference of a clamping ring with a plurality of openings between a plurality of second locking ramps disposed about an outer surface of the second component and rotating the clamping ring until the plurality of first locking ramps are secured to the plurality of second locking ramps by a friction fit. The clamping ring rotatably seated on a mounting flange of the first component.

The present summary is provided only by way of example, and not limitation. Other aspects of the present disclosure will be appreciated in view of the entirety of the present disclosure, including the entire text, claims and accompanying figures.

### BRIEF DESCRIPTION OF THE DRAWINGS

FIG. 1 is an isometric view of an exemplary antenna being assembled to a tripod with a clamping device.

FIG. 2 is an exploded view of FIG. 1.

FIG. 3 is an enlarged view of portion 3 of FIG. 2 showing the components of the clamping device.

FIG. 4 is an isometric top view of mounting seat of the clamping device of FIG. 1.

FIG. 5A is an isometric top view of a clamping ring of the clamping device of FIG. 1.

FIG. 5B is an isometric bottom view of the clamping ring of FIG. 6A.

FIG. 6 is a cross-sectional view of the clamping device of FIG. 3.

FIGS. 7A and 7B are side views of locking ramps of the clamping ring of FIGS. 5A and 5B and the mounting seat of FIG. 4. FIG. 7A shows the clamping device in an unlocked position. FIG. 7B shows the clamping device in a locked position.

FIGS. 8A-8C are top views of the locking ramps of clamping ring of FIGS. 5A and 5B and the mounting seat of FIG. 6. FIG. 8A shows the clamping device in an unlocked position.

FIG. 8B shows the clamping device in a state of being moved to a locked position. FIG. 8C shows the clamping device in a locked position.

FIG. 9 is an isometric view of a section of the clamping ring of FIGS. 5A and 5B with a handle in a state of being moved to a deployed position for assembly and disassembly of the equipment and base structure.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

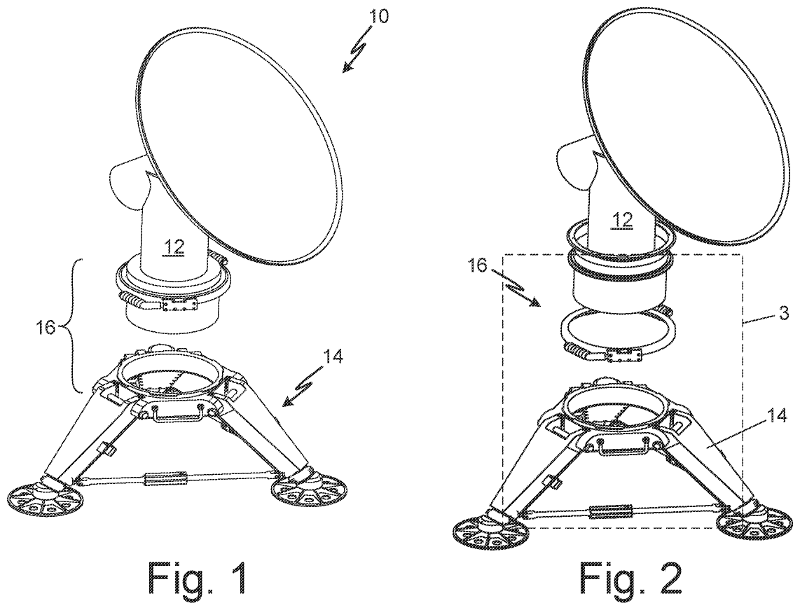

FIG. 1 is an isometric view of an application of the clamping device for mounting equipment to a base structure. FIG. 1 shows assembly 10 with component 12, base structure 14, and clamping device 16. Assembly 10 is shown in a disassembled state. Clamping device 16 is used to mount component 12 to base structure 14.

Component 12 can be any of a variety of components that can be mounted to a base structure. Component 12 can be, for example, man-transportable equipment, including but not limited to an antenna pedestal for satellite communication, telescope, optical sight, sensors, cameras, weapon systems, and similar equipment. Component 12 can be configured for field use including use in harsh environmental conditions.

Base structure 14 can be any of a variety of structures used for mounting component 12. Base structure 14 can be, for example, a tripod, as shown in FIG. 1, or other mounting structure. Base structure 14 is not limited to a stand-alone structure. Base structure 14 can be part of another stationary or mobile structure to which component 12 is mounted. The configuration, material composition, and size of base structure 14 is not limited to any particular embodiment. It will be understood by one of ordinary skill in the art that base structure 14 can have any configuration suitable for mounting component 12 in a desired configuration.

Clamping device 16 is integrated with component 12 and base structure 14. Clamping device 16 is configured to fixedly mount or attach component 12 to base structure 14 with a secure locking connection suitable for rapid in-the-field assembly and use, including assembly and use in harsh environmental conditions (e.g., high winds, dust, debris, precipitation, etc.). Clamping device 16 does not include loose components and does not require tools for mounting component 12 to base structure 14 or for disassembling component 12 from base structure 14. Clamping device 16 includes features that improve ease of assembly and disassembly and allow for rapid setup and take down of component 12. It will be understood by one of ordinary skill in the art that clamping device 16 can be applied to any application requiring a stiff, rapidly connectable interface between two cylindrical features. Clamping device 16 is configured to provide clamping action that centers component 12 with respect to base structure 14 and friction locks component 12 to base structure 14 with only hand-applied torque from a user. Components of clamping device 16 can be manufactured from any material suitable for field application and capable of providing a secure, self-locking, friction fit. Components of clamping device 16 can be formed, for example, from aluminum alloys. Components and/or features of clamping device 16 can be coated or can be formed from materials selected to provide protection in field applications and/or to reduce wear.

The orientation of component 12, base structure 14, and clamping device 16 is not limited to the vertical orientation shown. It will be understood by one of ordinary skill in the art that clamping device 16 can be configured to mount component 12 to a corresponding base structure 14 in any desired orientation. Furthermore, features of clamping device 16 (e.g., handles or other structures used for ease of assembly) can be modified to accommodate alternative orientations.

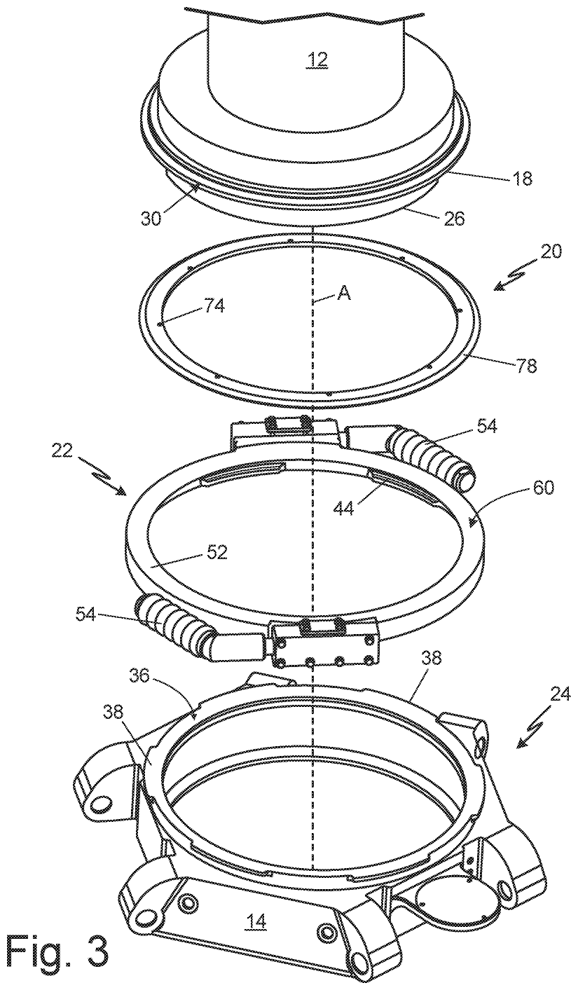

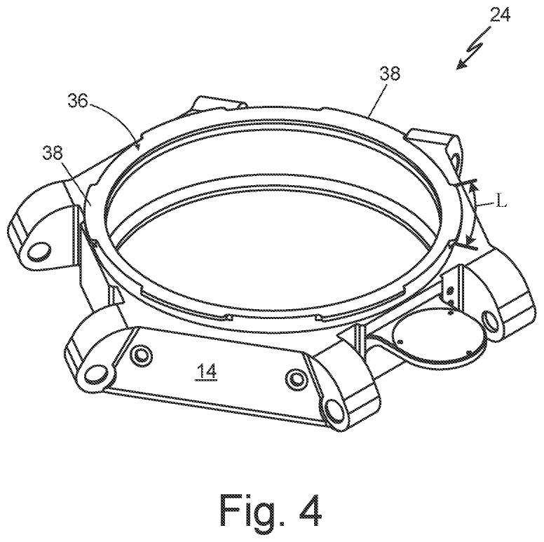

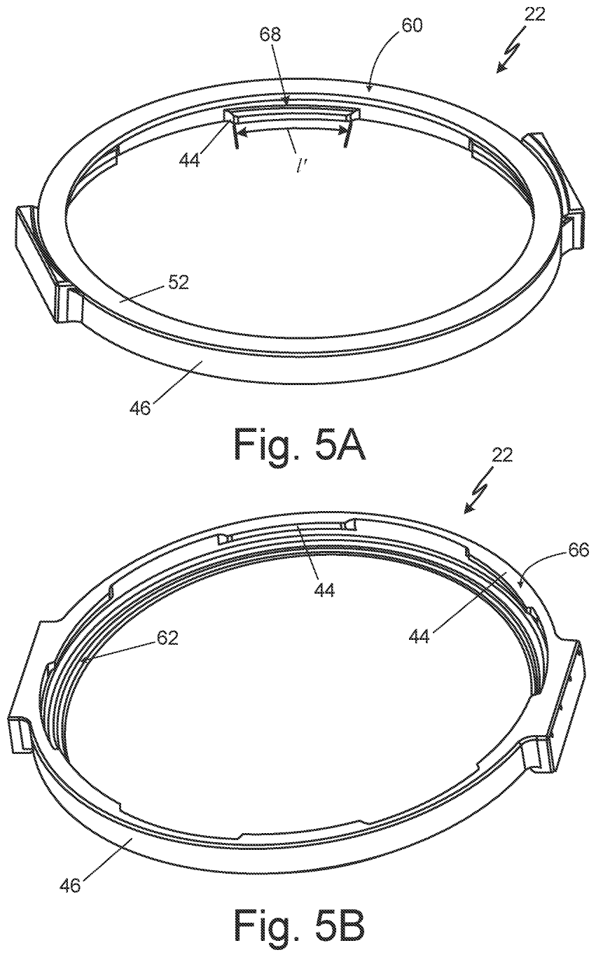

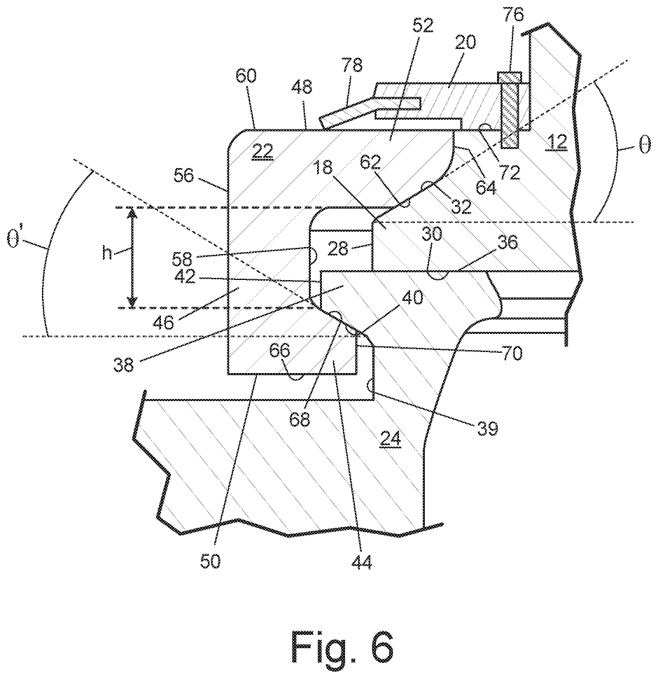

FIG. 2 is an exploded view of assembly 10. FIG. 2 shows component 12, base structure 14, and components of clamping device 16. FIG. 3 is an enlarged view of portion 3 of FIG. 2. FIG. 3 shows components of clamping device 16 in exploded view, including mounting flange 18 of component 12, retention ring 20, clamping ring 22, and mounting seat 24. FIG. 4 is an enlarged view of mounting seat 24. FIGS. 5A and 5B are enlarged views of clamping ring 22. FIG. 4 is an isometric top view of mounting seat 24. FIG. 5A is an isometric top view of clamping ring 22. FIG. 5B is an isometric bottom view of clamping ring 22. FIG. 6 is a cross-sectional view of clamping device 16 in an assembled state. FIG. 6 shows mounting flange 18 of component 12, retention ring 20, clamping ring 22, and mounting seat 24 in a locked relationship. FIGS. 2-6B are discussed together herein.

Component 12 includes mounting flange 18. Mounting flange 18 is configured to be seated on mounting seat 24. Clamping ring 22 is configured to secure mounting flange 18 to mounting seat 24. Clamping device 16 and mounting portions of component 12 (i.e., mounting flange 18) and base structure 14 (i.e., mounting seat 24) can be aligned about a common axis A as shown in FIG. 3.

Mounting flange 18 can be integrally formed with component 12 or can be fixedly attached to component 12 (e.g., by welding, brazing, mechanical fasteners, etc.). Mounting flange 18 extends radially outward from an exterior surface of component 12. As shown in FIGS. 1-3 mounting flange 18 can be provided at a location axially inward from an outermost end 26 of component 12 to allow an end portion of component 12 to be received in base structure 14 for improved stability of assembly 10. Mounting flange 18 can have an annular shape, fully circumscribing an outer circumference or extending around an exterior surface of component 12 to provide a more secure and sealed fit with mounting seat 24.

As shown in FIG. 6, mounting flange 18 includes end 28 separating opposing surfaces 30 and 32. End 28 is a radially outermost extent of mounting flange 18. Surface 30 is configured to be seated on mounting seat 24. Surface 32 is configured to be captured by clamping ring 22. End 28 is curved in a circumferential direction about axis A (shown in FIG. 3). Surface 30 can be flat. Surface 30 can be disposed in a plane perpendicular to axis A. Surface 32 can be oriented at angle θ with respect to a plane parallel to surface 30 or perpendicular to axis A. Angle θ can be selected to provide an optimized clamping force. As described further herein, angle θ can be substantially equal to and opposing angle θ′ at ramp contact. Preferably, angle θ of surface 32 is between 20° and 50°. In the exemplary embodiment, angle θ of surface 32 is 30°.

Mounting seat 24 can be integrally formed with base structure 14 as shown FIG. 5 or can be fixedly attached to base structure 14 (e.g., by welding, brazing, mechanical fasteners, etc.). For example, mounting seat 24 can include holes (not shown) for fixing an annular body of mounting seat 24 to base structure 14 via a plurality of fasteners. Mounting seat 24 has surface 36 configured to seat mounting flange 18 of component 12. Surface 36 can be disposed in a plane perpendicular to axis A and parallel to surface 30 of mounting flange 18. As shown in FIGS. 1-3 and 5 mounting seat 24 can be provided at an axially outermost extent of base structure 14. Mounting seat 24 can have a central opening configured to receive end 26 of component 12 upon assembly.

Mounting seat 24 includes a plurality of locking ramps 38. Locking ramps 38 extend radially outward from mounting seat 24. Locking ramps 38 can extend radially outward from annular surface 39 of mounting seat 24. Locking ramps 38 form a portion of surface 36. As shown in FIG. 6, locking ramps 38 have surfaces 40 disposed opposite surfaces 36 and separated by ends 42. Ends 42 are a radially outermost extent of locking ramps 38. Ends 42 are curved in a circumferential direction about axis A. Surfaces 40 are configured to be captured by clamping ring 22. Surfaces 40 can be oriented at angle θ′ with respect to a plane parallel to surface 36 or perpendicular to axis A. Angle θ′ can be selected to provide an optimized clamping force. Angle θ′ can substantially equal to and opposing angle θ at surface 32 of mounting flange 18. Preferably, angle θ′ of surfaces 40 is between 20° and 50°. In the exemplary embodiment, angle θ′ of surfaces 40 is 30°.

As disclosed further herein, surfaces 40 form a ramp portion of locking ramps 38. Surfaces 40 can have a shape of a helical segment, angling in a circumferential direction with lead angle a. Thicknesses of locking ramps 38 extending between surfaces 36 and surfaces 40 can taper in the circumferential direction and radial direction.

In an assembled state, surfaces 30 of mounting flange 18 can be directly seated on surface 36 of mounting seat 24. The radial extent measured from axis A of end 28 of mounting flange 18 can be less than the radial extent of ends 42 of locking ramps 38 such that a portion of surfaces 36 of mounting seat 24 are exposed or not covered by mounting flange 18.

Locking ramps 38 can be equally spaced about mounting seat 24. Each locking ramp 24 can have an arc length l. Arc lengths l of locking ramps 38 can be equal. A distance between adjacent locking ramps 38 can be equal to or greater than arc length l. Adjacent locking ramps 38 are spaced apart to receive corresponding locking ramps 44 of clamping ring 22 as described further herein.

Clamping ring 22 is configured to capture mounting flange 18 and locking ramps 38 upon application of torque when mounting flange 18 is seated on mounting seat 24. Clamping ring is rotatably mounted on component 12. Clamping ring 22 is retained in a first axial direction by mounting flange 18. As described further herein, clamping ring 22 can be retained in a second, opposite, axial direction by retention ring 20. Clamping ring 22 can be mounted on component 12 during assembly of component 12 such that clamping ring 22 is retained on component 12 during deployment of component 12.

Clamping ring 22 includes annular body 46, ends 48 and 50, annular flange 52, locking ramps 44, and handle 54. Annular body 46 extends axially between ends 48 and 50 and radially between exterior surface 56 and interior surface 58. Annular flange 52 extends radially inward (toward axis A) from annular body 46 at end 48. Locking ramps 44 extend radially inward from body 46 at end 50. Locking ramps 44 are axially separated from annular flange 52 by a height h selected to accommodate thicknesses of each of mounting flange 18 and locking ramps 38. One or more handles 54 are disposed on exterior surface 56 of annular body 46. Clamping ring 22 is configured to securely capture locking ramps 38 of mounting seat 24 and mounting flange 18 of component 12. Clamping ring 22 is configured to securely capture locking ramps 38 with locking ramps 44 via friction fit as further described herein.

Annular flange 52 can be retained in a first axial direction by mounting flange 18 of component 12. Annular flange 52 is configured to capture and apply clamping force to mounting flange 18 when component 12 is securely mounted on base structure 14. Annular flange 52 includes surfaces 60 and 62 separated by end 64. End 64 is a radial innermost extent of annular flange 52. End 64 can abut an axially extending surface of mounting flange 18 or component 12. End 64 is curved in a circumferential direction about axis A.

Surface 60 is a free exterior surface. Surface 60 can be flat. Surface 60 can be disposed in a plane perpendicular to axis A. Surface 62 is an interior surface configured to interface with surface 32 of mounting flange 18. At least a portion of surface 62 is oriented at angle θ. Surfaces 62 and 32 are parallel and can fully contact in assembly with base structure 14 such that an evenly distributed clamping force is applied across mounting flange 18. As previously described, angle θ can be selected to provide an optimized clamping force. As described further herein, angle θ can be substantially equal to and opposing angle θ′ at ramp contact. Preferably, angle θ of surface 62 is between 20° and 50°. In the exemplary embodiment, angle θ of surface 62 is 30°.

As shown in FIGS. 5A, 5B, and 6, locking ramps 44 have surfaces 66 disposed opposite surfaces 68 and separated by ends 70. Ends 70 are a radially innermost extent of locking ramps 44. Ends 70 are disposed adjacent axially extending annular surface 39 of mounting seat 24. Ends 70 can be spaced from annular surface 39 by a radial gap. Ends 70 can have a shorter radial extent than annular flange 52 such that ends 70 are positioned radially outward of end 64 of annular flange 52 and radially outward of annular surface 39 to allow locking ramps 44 to be received between adjacent locking ramps 38. Ends 70 can be positioned radially outward of end 28 of mounting flange 18 to allow assembly of clamping ring 22 on mounting flange 18. Ends 70 are curved in a circumferential direction about axis A.

Surfaces 66 are free or exterior surfaces. Surfaces 68 are interior surfaces configured to capture corresponding locking ramps 38 of mounting seat 24. Surfaces 68 are oriented at angle θ′. Surfaces 68 and 40 are parallel and can fully contact such that an evenly distributed clamping force is applied to locking ramps 38. As previously described, angle θ′ can be selected to provide an optimized clamping force. Angle θ′ can be substantially equal to and opposing angle θ at surface 32 of mounting flange 18 to generate self-centering action during rotation of clamping ring 22. Preferably, angle θ′ of surfaces 40 and 68 is between 20° and 50°. In the exemplary embodiment, angle θ′ of surfaces 40 and 68 is 30°.

Surfaces 68 form a ramp portion of locking ramps 44. Surfaces 68 can have a shape of a helical segment, angling in a circumferential direction with lead angle a. The surface profile of surfaces 68 can match a profile of opposing surfaces 40 of locking ramps 38. Thicknesses of locking ramps 68 extending between surfaces 66 and surfaces 68 can taper in the circumferential direction and radial direction.

Locking ramps 44 can be equally spaced about clamping ring 22 as shown in FIGS. 5A and 5B. Each locking ramp 44 can have an arc length l′. Arc lengths l′ can be equal. Arc lengths l′ can be similar in length to arc lengths l of locking ramps 38 of mounting seat to provide maximum contact and overlap of ramp surfaces 40 and 68, leading to greater stiffness across the joint and minimized stress concentrations. Arc length l′ can be slightly less than an arc length of the gap between adjacent locking ramps 38 to allow locking ramps 44 to be received between locking ramps 38. Arc lengths l′ can be, for example, 80-95% of arc length l. In the disclosed embodiment, arc lengths l′ are approximately 10% shorter than arc lengths l. Arc lengths l′ can be slightly shorter than arc lengths l to account for tolerance variation, which will induce more or less rotation of clamping ring 22 to achieve the same axial preload for a given torque. Adjacent locking ramps 44 are spaced apart to receive corresponding locking ramps 38 of mounting seat 24. A distance between adjacent locking ramps 44 can be slightly greater than arc length l to allow locking ramps 38 to be received between adjacent locking ramps 44. The number of locking ramps 44 is equal to the number of locking ramps 38.

During assembly, clamping ring 22 is axially aligned with mounting seat 24. Clamping ring 22 can be turned to locate locking ramps 44 between adjacent locking ramps 38 in mounting seat 24 and allowing surface 30 of mounting flange 18 to be seated on surface 36 of mounting seat 24. A locating feature (e.g., alignment arrows) can be provided on clamping ring 22 and mounting seat 24 or base structure 14 during mating to position locking ramps 44 between adjacent locking ramps 38. Interior surface 58 of clamping ring 22 is disposed radially outward from ends 42 of locking ramps 38 such that locking ramps 38 can be received in clamping ring 22.

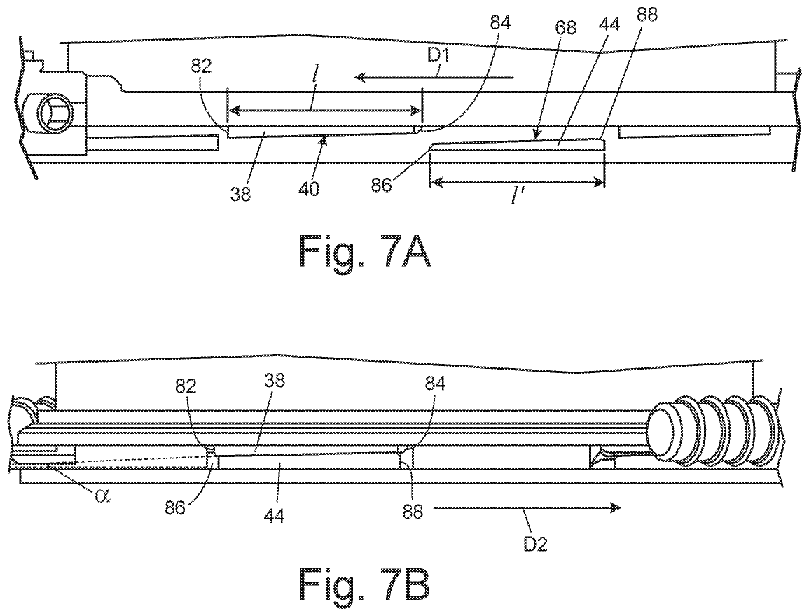

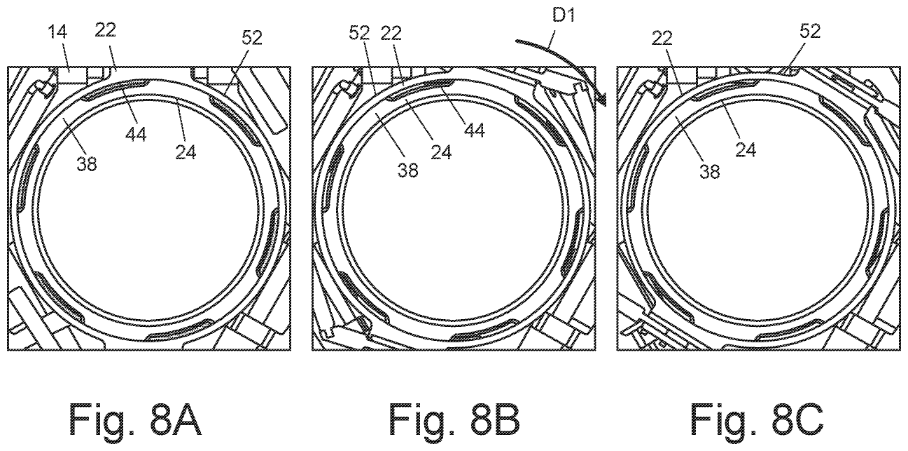

When mounting flange 18 is seated on mounting seat 24, clamping ring 22 can be turned approximately one arc length l, forcing locking ramps 38 and 44 into alignment and forming a friction fit at surfaces 40 and 68, as illustrated and in FIGS. 7A, 7B, and 8A-8C and discussed further herein.

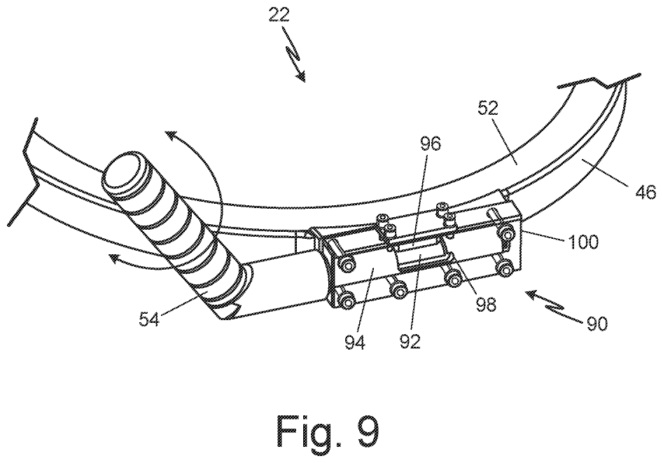

One or more handles 54 are disposed on exterior surface 56 of annular body 46. Handle 54 is configured to allow a user to apply torque to clamping ring 22 during assembly and disassembly of component 12 to base structure 14. Handle 54 is further described with respect to FIG. 9.

Retention ring 20 can be provided to axially retain clamping ring 22 on component 12. Clamping ring 22 can be rotatably seated between mounting flange 18 and retention ring 20. Retention ring 20 can axially restrain movement of clamping ring 22 while allowing for rotational movement of clamping ring 22. Retention ring 20 can be seated on surface 72 of component 12 adjacent to mounting flange 18. Surface 72 can be parallel to surface 30 of mounting flange 18. Retention ring 20 can be fixed to component 12 by any suitable fastening means. For example, retention ring 20 can include holes 74 (shown in FIG. 3) configured to receive fasteners 76 (shown in FIG. 6). Retention ring 20 can include annular seal 78. Annular seal 78 can be a wiper seal configured to keep water and debris out of locking interfaces (e.g., locking ramps 38 and 44) during operation. Annular seal 78 can be coupled to retention ring 20 by any of a variety of known means. Annular seal 78 can extend from a radially outer edge of retention ring 20. Annular seal 78 is configured to contact exterior surface 60 of clamping ring 22.

FIGS. 7A and 7B are side views of locking ramps 38 and 44 of mounting seat 24 and clamping ring 22, respectively. FIG. 7A shows clamping device 16 in an unlocked position. FIG. 7B shows clamping device 16 in a locked position. Annular body 46 is removed from view to show the interaction of locking ramps 38 and 44. Locking ramps 38 extend in a circumferential direction between ends 82 and 84. Locking ramps 44 extend in a circumferential direction between ends 86 and 88. Ends 82, 84, 86, and 88 can be contoured.

Ends 82 of locking ramps 38 are disposed adjacent to ends 88 of locking ramps 44 and ends 84 of locking ramps 38 are disposed adjacent to ends 86 of locking ramps 44 in the unlocked position shown in FIG. 7A. Surfaces 40 of locking ramps 38 and surfaces 68 of locking ramps 44 form segments of a helix. Surfaces 40 of locking ramps 38 have a lead angle a equal to a lead angle a of surfaces 68 of locking ramps 44. The lead angle a is based on the lead of the ramp helix and circumference of clamping ring 22 and/or mounting seat 24. In one embodiment, lead angle a can be less than approximately 2°, which will ensure a good margin on frictional locking for most material combinations. Lead angle a is a function of the effective diameter (D) of locking ramps 38, 44, given by TAN (lead angle)=lead/(ID). Lead is the axial distance the helix advances over a full rotation (i.e., the distance between threads if each locking ramp were extended to form a complete helical structure). The number and length of locking ramps 38, 44 can be selected to provide a desired axial gap between adjacent locking ramps 38 and 44 at start of locking action (before clamping ring 22 is rotated into the locked position). In some embodiments, lead angle a can be less than 1°.

Locking ramp 38 can taper inward in thickness from end 82 to end 84, forming ramp surface 40. Locking ramp 44 can taper outward in thickness from end 86 to end 88, forming ramp surface 68 corresponding to ramp surface 40.

Clamping ring 22 is rotated in direction D1 to securely mount component 12 to base structure 14. Rotation of clamping ring 22 in direction D1 locks ramps 38 and ramps 44 in a friction fit by wedging locking ramps 44 under locking ramps 38. Rotation in direction D1 can be approximately equal to arc length l. While arc length l can vary based on the number of locking ramps 38 and 44, preferably, arc length l can be slightly less than the angular locking rotation. As previously discussed, in the disclosed embodiment, the angular locking rotation is 30°, however, smaller or larger values of angular locking rotation may be implemented based on the design intent of the device.

As shown in FIG. 7B, locking ramp 44 is received under locking ramp 38. Ramps 38 and 44 generate a compressive preload between component 12 and base structure 14, evenly distributing clamping force around a circumference of the interface (surfaces 30 and 36), resulting in a uniformly stiff connection that is friction-locked, due to a low lead angle a. Angle θ at the interface of mounting flange 18 and annular flange 52 of clamping ring is equal to an opposing angle θ′ at the interface of locking ramps 38 and 44. As a result, wedging action is generated in the circumferential, axial, and radial directions simultaneously during rotation clamping ring 22.

A low lead angle a of ramps 38 and 44 can provide self-locking action even at very low friction coefficients. Stress in components of clamping device 16 is kept low due to large contact areas and contoured transitions.

Clamping ring 22 can be rotated in direction D2 with sufficient application of torque to unlock locking ramps 38 and 44 and remove component 12 from base structure 14.

FIGS. 8A-8C are top views of locking ramps 38 and locking ramps 44. Component 12 is removed from view. FIG. 8A shows clamping device 16 in an unlocked position. FIG. 8B shows clamping device 16 in a state of being moved to a locked position or a partially locked position. FIG. 8C shows clamping device 16 in a locked position. Clamping ring 22, annular flange 52, locking rings 44, base structure 14, mounting seat 24, and locking ramps 38 are shown. As illustrated in FIG. 8A, locking ramps 44 are disposed between adjacent locking ramps 38 in the unlocked position. As clamping ring 22 is rotated, locking ramps 44 slide under locking ramps 38 (FIG. 8B). As illustrated in FIG. 8C, clamping ring 22 is rotated approximately 30° in direction D1 to reach the locked position in which locking ramps 44 are positioned directly under locking ramps 38.

The degree of rotation for locking (angular locking rotation) depends on the number of locking ramps 38, 44. Preferably, the angular locking rotation is chosen to provide a desired feel for the user, and a reasonable sized axial start gap between adjacent locking ramps 38 and 44 in the unlocked position of the ring, which can accommodate initial misalignments and allow the ramps to begin to engage (overlap) each other. In one exemplary embodiment, the angular locking rotation can be 30°, however, as previously discussed, smaller or larger angular locking rotation values may be selected based on the design intent of the device. It will be understood by one of ordinary skill in the art that the number of ramps, lead angle a, and ramp flank angle θ can be selected to provide secure self-locking with an application of torque that can be applied by a user in the field without the use of tools.

FIG. 9 is an isometric view of clamping ring 22 with handle 54 in a state of being moved to a deployed position for assembly and disassembly of component 12 to base structure 14. As shown in FIG. 1, clamping ring 22 can include two handles 54 disposed on opposite sides of clamping ring 22. Handles 54 can be mounted to clamping ring or can be integrally formed with or fixed to clamping ring 22. In some embodiments, handles 54 can include deployment mechanism 90. Deployment mechanism 90 can be configured to allow handles 54 to be placed in a stowed position shown in FIGS. 1 and 3 and in a deployed position for ease of use. In the stowed position, handles 54 can be disposed in a plane with clamping ring 22. For use, handles 54 can be rotated outward, as shown in FIG. 9. The deployed position can be any position that allows a user to grasp handles 54 and apply torque by hand. The deployed position can be selected to provide a grip suitable for applying a required torque. In an exemplary embodiment with a 1.8 ft (30.48 cm) effective handle separation, 30 lbf (4.45 N) minimum push/pull force generates approximately 54 ft-lb (1.36 Nm) clamp ring torque by hand.

Deployment mechanism 90 can be a spring lock mechanism. Deployment mechanism 90 can include sealed housing 100 configured to protect components of deployment mechanism 90. For example, handle 54 can include shaft 94 slidably received in housing 100 of deployment mechanism 90. Shaft 94 can include locking pocket 92. Locking member 96 can be a protrusion extending radially inward from housing 100 and received in pocket 92 of shaft 94, capturing shaft 94 in housing 100. Locking member 96 can be, for example, a rectangular body as shown in FIG. 9 or a pin. Pocket 92 in deployment mechanism 90 includes two slots (a first slot not shown and slot 98). Handle 54 can be pulled (or pushed in an alternative assembly) from the locked position to disengage locking member 96 from the first slot (not shown). Handle 54 can be turned to a deployed orientation. Locking member 96 can be captured in slot 98 and held by spring force in the deployed position (spring not shown). Handle 54 can be restowed once clamping ring 22 is secured in a locked position.

Clamping device 16 provides a combination of rapid connection, distributed clamping load, and captivated fastening with no required tools and in a compact form. As disclosed, clamping device 16 can be adapted for use with a wide variety of components 12 and base structures 14 and can provide secure and stable mounting with rapid setup for a variety of in-the-field applications. Clamping device 16 is not as susceptible to environmental contamination as prior solutions. Large, smooth interface surfaces of locking ramps 38, 44 are easily wiped clean, mitigating dirt and dust contamination of sliding interfaces in the field. The disclosed retainer ring 20 and annular seal 78 axially retrain clamping ring 22 on component 12 and keep water and debris out of ramp interfaces in assembly and operation.

The embodiments disclosed herein are intended to provide an explanation of the present invention and not a limitation of the invention. The present invention is not limited to the embodiments disclosed. It will be understood by one skilled in the art that various modifications and variations can be made to the invention without departing from the scope and spirit of the invention.

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, rotational or vibrational operational conditions, and the like. Moreover, any relative terms or terms of degree used herein should be interpreted to encompass a range that expressly includes the designated quality, characteristic, parameter or value, without variation, as if no qualifying relative term or term of degree were utilized in the given disclosure or recitation.

### Discussion of Possible Embodiments

The following are non-exclusive descriptions of possible embodiments of the present invention.

A clamping device for securing a first component to a second component is disclosed. The clamping device includes a mounting flange coupled to the first component, a mounting seat coupled to the second component, and a clamping ring configured to be rotatably seated on the mounting flange such that the mounting flange is disposed axially between a first end of the clamping ring and the mounting seat upon assembly. The mounting seat includes a plurality of first locking ramps disposed about a circumference of the mounting seat and extending radially outward from the mounting seat. The clamping ring includes a plurality of second locking ramps disposed about an inner circumference and extending radially inward from a second end of the clamping ring. The plurality of second locking ramps is configured to engage the plurality of first locking ramps upon securing the first component to the second component.

The clamping device of the preceding paragraph can optionally include, additionally and/or alternatively, any one or more of the following features, configurations and/or additional components:

In an embodiment of the forgoing clamping device, each of the annular mounting flange and the plurality of first locking ramps can have a first surface and a second surface. The first surface of the mounting flange can be configured to be disposed in contact with the first surfaces of the plurality of first ramps upon securing the first component to the second component. The second surface of the mounting flange and the second surfaces of the plurality of first locking ramps can be configured to be in contact with the clamping ring upon securing the first component to the second component.

In an embodiment of any of the forgoing clamping devices, the first surfaces can be disposed in a plane perpendicular to an axis of the mounting flange and mounting seat and the second surfaces can be angled with respect to the plane.

In an embodiment of any of the forgoing clamping devices, the second surfaces can be disposed at an angle of approximately 30 degrees from the plane.

In an embodiment of any of the forgoing clamping devices, the clamping ring can include an annular flange extending radially inward from the first end, the annular flange having a third surface disposed adjacent to the first surface of the mounting flange.

In an embodiment of any of the forgoing clamping devices, each second locking ramp of the plurality of second locking ramps can include a fourth surface, each fourth surface configured to provide a friction fit with a corresponding second surface of the plurality of first locking ramps upon securing the first component to the second component.

In an embodiment of any of the forgoing clamping devices, the fourth surfaces of the plurality of second locking ramps and the second surfaces of the plurality of first locking ramps can be inclined in a circumferential direction forming segments of a helix with a lead angle.

In an embodiment of any of the forgoing clamping devices, the first locking ramps of the plurality of first locking ramps can be equally spaced about the circumference of the mounting seat and have a first arc length and wherein each second locking ramp of the plurality of second locking ramps has a second arc length, the second arc length less than the first arc length.

In an embodiment of any of the forgoing clamping devices, the lead angle can be less than approximately two degrees.

In an embodiment of any of the forgoing clamping devices, the clamping ring can further include a handle disposed on an outer circumference, the handle can be configured to allow a user to apply torque to the clamping ring to rotate the clamping ring relative to the mounting flange and the plurality of first locking ramps to secure the first component to the second component.

An embodiment of any of the forgoing clamping devices can further include a retention member disposed on the first component to retain the clamping ring on the mounting flange, the first end of the clamping ring disposed axially between the retention member and the mounting flange.

In an embodiment of any of the forgoing clamping devices, the retention member can be an annular body and comprises an annular seal on a radially outer edge, the annular seal disposed in contact with a surface of the first end of the clamping ring.

In an embodiment of any of the forgoing clamping devices, the mounting flange and the mounting seat can be annular and wherein the mounting flange extends a first radial distance from the axis and the plurality of first locking ramps extend a second radial distance from the axis, the second radial distance greater than the first radial distance.

In an embodiment of any of the forgoing clamping devices, the clamping ring can include an annular body extending between the first end and the second end, wherein the plurality of second locking ramps can extend from the second end of the annular body radially inward, and wherein the clamping ring can further include an annular flange, the annular flange extending from the first end radially inward, wherein a radial extent of the annular flange can be greater than a radial extent of the plurality of second locking ramps.

A method of securing a first component to a second component includes aligning a plurality of first locking ramps disposed about an inner circumference of a clamping ring and rotating the clamping ring until the plurality of first locking ramps are secured to a plurality of second locking ramps by a friction fit. The clamping ring rotatably seated on a mounting flange of the first component, with a plurality of openings between a plurality of second locking ramps disposed about an outer surface of the second component.

The method of the preceding paragraph can optionally include, additionally and/or alternatively, any one or more of the following features, configurations, additional components, and/or steps:

In an embodiment of the foregoing method, rotating the clamping ring can include simultaneously pushing a first handle disposed on an outer circumference of the clamping ring and pulling a second handle disposed on the outer circumference of the clamping ring.

And embodiment of any of the foregoing methods can further include deploying the handles from a stowed and locked position to deployment position prior to rotating the clamping ring.

In an embodiment of any of the forgoing methods, interfacing surfaces of the plurality of first locking ramps and the plurality of second locking ramps can be inclined in the circumferential direction forming segments of a helix with a lead angle less than approximately two degrees.

In an embodiment of any of the forgoing methods, the interfacing surfaces of the plurality of first locking ramps and the plurality of second locking ramps can be disposed at a first angle relative to a plane perpendicular to a common axis of the clamping ring and the second component and wherein interfacing surfaces of the clamping ring and the mounting flange can be disposed at an opposing second angle equal to the first angle.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A clamping device for securing a first component to a second component, the clamping device, first component, and second component disposed on a common axis, the clamping device comprising:
a mounting flange coupled to the first component;
a mounting seat coupled to the second component, the mounting seat comprising a plurality of first locking ramps disposed about a circumference of the mounting seat and extending radially outward from the mounting seat; and
a clamping ring configured to be rotatably seated on the mounting flange such that the mounting flange is disposed axially between a first end of the clamping ring and the mounting seat upon assembly, the clamping ring comprising a plurality of second locking ramps disposed about an inner circumference and extending radially inward from a second end of the clamping ring, the plurality of second locking ramps configured to engage the plurality of first locking ramps upon securing the first component to the second component.

2. The clamping device of claim 1, wherein each of the annular mounting flange and the plurality of first locking ramps has:
a first surface, the first surface of the mounting flange configured to be disposed in contact with the first surfaces of the plurality of first ramps upon securing the first component to the second component; and
a second surface, the second surface of the mounting flange and the second surfaces of the plurality of first locking ramps configured to be in contact with the clamping ring upon securing the first component to the second component.

3. The clamping device of claim 2, wherein the first surfaces are disposed in a plane perpendicular to an axis of the mounting flange and mounting seat, and wherein the second surfaces are angled with respect to the plane.

4. The clamping device of claim 3, wherein the second surfaces are disposed at an angle of approximately 30 degrees from the plane.

5. The clamping device of claim 3, wherein the clamping ring comprises an annular flange extending radially inward from the first end, the annular flange having a third surface disposed adjacent to the first surface of the mounting flange.

6. The clamping device of claim 5, wherein each second locking ramp of the plurality of second locking ramps comprises a fourth surface, each fourth surface configured to provide a friction fit with a corresponding second surface of the plurality of first locking ramps upon securing the first component to the second component.

7. The clamping device of claim 6, wherein the fourth surfaces of the plurality of second locking ramps and the second surfaces of the plurality of first locking ramps are inclined in a circumferential direction forming segments of a helix with a lead angle.

8. The clamping device of claim 7, wherein the first locking ramps of the plurality of first locking ramps are equally spaced about the circumference of the mounting seat and have a first arc length and wherein each second locking ramp of the plurality of second locking ramps has a second arc length, the second arc length less than the first arc length.

9. The clamping device of claim 8, wherein the lead angle is less than approximately two degrees.

10. The clamping device of claim 1, wherein the clamping ring further comprises a handle disposed on an outer circumference, the handle configured to allow a user to apply torque to the clamping ring to rotate the clamping ring relative to the mounting flange and the plurality of first locking ramps to secure the first component to the second component.

11. The clamping device of claim 1, and further comprising a retention member disposed on the first component to retain the clamping ring on the mounting flange, the first end of the clamping ring disposed axially between the retention member and the mounting flange.

12. The clamping device of claim 11, wherein the retention member is an annular body and comprises an annular seal on a radially outer edge, the annular seal disposed in contact with a surface of the first end of the clamping ring.

13. The clamping device of claim 1, wherein the mounting flange and the mounting seat are annular and wherein the mounting flange extends a first radial distance from the axis and the plurality of first locking ramps extend a second radial distance from the axis, the second radial distance greater than the first radial distance.

14. The clamping device of claim 13, wherein the clamping ring comprises an annular body extending between the first end and the second end, wherein the plurality of second locking ramps extend from the second end of the annular body radially inward, and wherein the clamping ring further comprises an annular flange, the annular flange extending from the first end radially inward, wherein a radial extent of the annular flange is greater than a radial extent of the plurality of second locking ramps.

15. A method of securing a first component to a second component, the method comprising:
aligning a plurality of first locking ramps disposed about an inner circumference of a clamping ring, the clamping ring rotatably seated on a mounting flange of the first component, with a plurality of openings between a plurality of second locking ramps disposed about an outer surface of the second component; and
rotating the clamping ring until the plurality of first locking ramps are secured to the plurality of second locking ramps by a friction fit.

16. The method of claim 15, wherein rotating the clamping ring comprises simultaneously pushing a first handle disposed on an outer circumference of the clamping ring and pulling a second handle disposed on the outer circumference of the clamping ring.

17. The method of claim 16 and further comprising deploying the handles from a stowed and locked position to deployment position prior to rotating the clamping ring.

18. The method of claim 17, wherein interfacing surfaces of the plurality of first locking ramps and the plurality of second locking ramps are inclined in the circumferential direction forming segments of a helix with a lead angle less than approximately two degrees.

19. The method of claim 17, wherein the interfacing surfaces of the plurality of first locking ramps and the plurality of second locking ramps are disposed at a first angle relative to a plane perpendicular to a common axis of the clamping ring and the second component and wherein interfacing surfaces of the clamping ring and the mounting flange are disposed at an opposing second angle equal to the first angle.
